(19) United States
(12) Patent Application Publication
(10) Pub. No.: US 2004/0186785 A1
(43) Pub. Date: Sep. 23, 2004

(54) Process and system for defining services within an information technology offering

(75) Inventors: Mack Basil, White Plains, NY (US); Giuseppe Paleologo, Bronx, NY (US); Logan Scott, New City, NY (US); Samer Takriti, Croton on Hudson, NY (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY

(21) Appl. No.: 10/390,898

(22) Filed: Mar. 19, 2003

(51) Int. Cl. G06F 17/60

(52) U.S. Cl. 705/26

(57) ABSTRACT

A process (and system) for defining transactions in an information technology offering, includes listing each transaction and service that may be delivered over a computer network under the information technology offering, and partitioning each transaction and service into different classes.

### BACKGROUND OF THE INVENTION

1. Field of the Invention

The present invention relates generally to information technology (IT) and contracts, and more particularly, to a process for identifying IT service elements that can be billed to a customer as standardized units of received services.

2. Description of the Related Art

Over the past 25 years, computers evolved from mainframes that required air conditioned buildings and specialized staff to desktops and laptops that are easy to use and operate. Most businesses realized that in order to be efficient, their information must be captured and stored in electronic form; so that it can be accessed and searched when needed. As a result, industries, such as the airline, banking, and manufacturing industries, invested billions of dollars in building an information technology infrastructure. Companies often used the sophistication of their IT infrastructures to distinguish themselves from their competitors. This trend became even more pronounced with the introduction of the Internet. Through the Internet, businesses found a low-cost vehicle that can reach every potential customer, regardless of his/her geographic location.

Today, the IT spending of any company, large or small, consumes a sizable amount of its budget. Furthermore, today's competitive market place requires each company to be efficient in its spending, particularly when it comes to IT, where the latest technology could be obsolete within 6 to 12 months. As a result, many companies choose to outsource their IT operations to firms that are specialized in operating IT efficiently and reliably.

In general, most companies have benefitted from outsourcing their IT. In a traditional IT outsource, the IT provider uses its expertise and skills to estimate the customer's needs and provide the required infrastructure in the form of a lease. For example, in the case of Web hosting, an IT expert studies the Web site at hand, its demand profile, and its expected future growth, and then recommends a Web-hosting strategy. The strategy is implemented as part of the outsourcing contract and the customer is charged to lease or purchase the needed infrastructure. Note that under the lease setup, a customer's cost is fixed as long as the traffic does not exceed the capacity of the existing infrastructure. If additional capacity is needed, then the contract often spells out terms and conditions under which the provided service may be altered.

Although the outsourcing model has been successful, customers have quickly realized that under the current model, cost and revenue are not correlated, which leads to a substantial financial exposure. In the case of Web hosting for example, the cost of the infrastructure is nearly independent of the number of users visiting the Web site. On the other hand, the revenue of a Web site is often driven by number of hits (e.g. Web-page accesses). As a result, even when cost is kept under control, the profit or loss becomes highly volatile due to return variability.

To reduce their financial exposure, companies have started to negotiate outsourcing contracts that charge based on service consumption as opposed to the traditional model which charges based on resource requirement. In the case of Web hosting, most service providers use metrics that are based on the rate of data transfer as measured in Megabits per second (Mbps). However, from the customer's standpoint, the financial benefit is usually linked to the number of objects browsed, also known as number of hits. Clearly, the rate of data transfer is not an accurate measure of the number of hits. Therefore, the cost of hosting a Web site to a customer and the financial benefit from it are not tightly correlated.

For a customer, a more attractive contract is one that charges based on the number of hits on the Web site. If the number of hits is large, then the cost to the customer is high but the reward is also high. In the case of having a small number of hits, the cost is small and the financial loss is minimized. Note that by structuring the contract so that cost is based on the expected benefit, the customer shifts its financial risk to the IT provider. When demand is low, the IT provider's return is relatively low, and the operation is most likely to lose money. However, when the number of hits is high and the Web site is profitable, the IT provider reaps some of this benefit, which offsets the losses in the long run. An advantage to the IT provider is its capability to share its resources among several customers, hence minimizing its fixed cost.

A further example of an outsourcing contract that charges based on service consumption is that of computing power, measured in CPU cycles and millions of instructions per second (MIPS). Often, a customer is interested in having access to large-scale computers to perform certain tasks. For a trading entity for example, traders receive continuous updates regarding market conditions and adjust their positions accordingly. In order to determine an optimal set of decisions, large-scale mathematical models with intensive CPU demand are solved. For a trader, the platform on which the calculations are performed is irrelevant. The main goal is to have access to certain computing power, which can be thought of as a commodity with a specific price.

In a traditional outsourcing model, an IT provider leases or buys the needed computer to perform the required tasks, while passing the cost to the customer. If the need arises for a faster computer, then the customer must ask the IT provider to replace the old machine, thereby incurring additional cost. The picture is significantly different in an environment where CPU capacity is offered in the form of a commodity; i.e., it is available all of the time at any required capacity. If the customer has the need for more computing capacity, the system offers these additional cycles automatically and charges the customer accordingly. On the other hand, if the demand for the computing power does not materialize, then the customer uses a small amount of the commodity, such as CPU cycles, and is charged accordingly.

A third example of an outsourcing contract that charges based on service consumption is that of data storage. Data is often stored on a centralized server that may or may not reside in the same facility as the user. By having access to a computer network, a user can access the data regardless of its location and the hardware on which it is stored. The commodity in this case is the storage capacity over a certain period of time. In a traditional outsourcing setting, the charges are a function of the cost of the hard disk or array of disks on which the data is stored. These charges are independent of the amount of data residing on the disk.

A further example of an outsourcing contract that charges based on service consumption is Internet-Protocol (IP) contracts. These types of contracts have two components. The first component is called a “port charge” and is a function of the port size that is used by the customer. As the port size reflects the maximum amount of traffic that can be served, the port charge is a function of the maximum possible demand to serve the IP traffic. The second price component for IP services is a “variable charge” that is based on the 95th percentile of the traffic. That is, at the end of the billing period, the traffic is ranked based on its rate and the threshold that partitions the traffic intensity into the top 5% versus the bottom 95% is determined. Note that the 95th percentile does not represent the average consumption of a customer. Instead, it is an approximation of the resources needed to serve the IP traffic.

Customers may feel that they are being overcharged when presented with such contracts and often have difficulties understanding them. More importantly, as a customer changes the design of its Web site by using more audio and video for example, the charges can increase substantially due to the increase in traffic as measured by the 95^{th} percentile in Megabits per billing cycle.

Billing based on perceived value of service is widely used for traditional utilities such as water, electricity, natural gas, and telephone services. In electricity service for example, customers are billed based on their consumption as measured in kWh. The charges per kWh may vary between on-peak and off-peak or between weekdays and weekends. However, the customer is completely insulated from the electricity company's cost of producing power. The cost for the electricity company is not linear. For example, starting an electric generator in response to demand increase involves a substantial cost which is not linear in the demand. The fact that the customer is not exposed to details related to generating electricity, such as fuel used, location where it is produced, power lines used, fuel cost, plant maintenance, is what makes electricity a service or a utility.

A further exemplary utility is long-distance telephone service. In order to maximize its revenue, the provider phone company segments its services. For example, charges are different between a weekday and a weekend. They also vary as a function of the zip code called. However, the customer has a clear understanding of its charges, which do not involve information related to the cost of the infrastructure of the phone company or network congestion. As discussed above, current IT outsourcing contracts consider the cost of the needed infrastructure to bill a client.

In summary, companies have started to replace traditional outsourcing contracts having charges based on resource requirements with contracts having charges based on service consumption. However, a company outsourcing IT services traditionally must continue to pay for IT infrastructure and upgrades, and the provider's expertise and skills as they are required. There is no systematic and objective procedure for billing IT services based on a perceived value of service to the customer.

### SUMMARY OF THE INVENTION

In view of the foregoing problems, drawbacks, and disadvantages of the conventional systems, it is a purpose of the present invention to provide a process and system in which customers are billed for IT services based on a metric that relates to the service the customer receives.

Another purpose of the present invention is to provide a process and system for the adoption of standard units of measure for received service in e-sourcing contracts.

That is, instead of structuring contracts so that customers are billed based on their share of the infrastructure, they are billed based on a metric that relates to the service they receive. Customer's bills for an information technology (IT) service are based on consumption of a service that impacts their business and its financial results; i.e., based on the perceived value of IT service.

Treating IT services as a commodity poses two challenges. The first is adopting appropriate measurement units that reflect the customer's perceived value of the service. Furthermore, these units must be flexible so that they can be modified to capture new business needs. The second is structuring IT contracts using these units so that risk is minimized for both the provider and the customer. What is needed, then, is a new model for IT contracts in which customers are charged based on their true usage of the IT services.

Another issue associated with the use of metrics that are based on resource consumption is that of technological changes. In the case of data transfer for example, the amount of data transmitted as measured in Mbits per web page has changed over the years. In the early 1990's, most pages contained pure text (e.g. gopher). Then, pages began to include graphics, which increased the amount of downloaded data significantly. Today, the amount of data needed to serve the textual content of a page is minimal, as most pages contain graphics, video, and audio. As a result, the present invention uses a virtual unit that is based on the perceived value of service; i.e., pages served. The cost associated with the delivery of such a unit is expected to change over time as a result of hardware advances and of new technologies to be delivered over the Internet.

IT services that can be offered over a network are known as “e-Business On Demand.” They are also called “e-utilities” or “e-sourcing.” Regardless of the name used, one can think of the service as a commodity. In the case of Web hosting, the service has the capability of serving packets over the Internet. The user does not care where and how the packets are produced. More importantly, the user does not care which platform is used to provide the service. For the CPU cycle example, the customer needs access to the computing power. As a matter of fact, a user is usually uninterested in the details of how and where the assigned tasks are performed.

The demand for services that can be delivered remotely is growing rapidly. Furthermore, the demand is expected to grow as organizations and individuals become more connected. An advantage for e-Business On Demand is that customers have access to the latest hardware and software through the provider, which allow them to focus on their core businesses while treating information technology as a tool that is available at their disposal. Another advantage for the e-Business On Demand model is that it links the customer's IT cost to the delivered service rather than to the needed infrastructure.

The process is centered around the customer's view of its IT operations and its received value from these operations. Furthermore, the methodology of the preferred embodiment allows the customer to think of IT as a service and to negotiate a price per unit of service, instead of negotiating prices on the base of the cost of the infrastructure required to accommodate this service.

An exemplary user of the process can be (1) a decision maker within an organization that is interested in outsourcing some or all of its IT services; (2) a consultant or an IT expert who is performing services to an organization that is interested in outsourcing some or all of its IT services to a third party, (3) an IT provider that is interested in identifying the IT components that can be considered as services by clients, etc.

In a first aspect of the present invention, a process for defining transactions in an information technology offering, includes listing each transaction and each service that may be delivered over a computer network under the information technology offering, and partitioning the each transaction and the each service into at least one of a plurality of different classes. A usage rate is defined for each of the classes, and at least one metric is defined for measuring the usage rate of each of the plurality of the classes that is independent of the information technology infrastructure. The units of the metric are translated into units of service.

In a second aspect of the present invention, a process for defining the value of services in an information technology offering, includes listing at least one transaction and service that may be delivered over a computer network to a customer under the information technology offering, partitioning the at least one transaction and service into at least one class, defining a usage rate of usage for the at least one class, defining at least one metric for measuring the rate of usage based upon the amount of customer service transactions within each of the at least one class, and translating the usage rate into a unit of service.

In a third aspect of the present invention, a method for calculating the units of service associated with usage of information technology service, includes listing each service that can be delivered over a computer network, partitioning the each service into different classes, defining at least one metric for measuring the rate of usage for each class of service that provides a measure for a customer's received value of the service, measuring the usage of the service by a customer, associating the measured service with the transaction rate for each class and determining a rate of usage for the each service, and translating the rate of usage for the each service into a unit of service.

In a fourth aspect of the present invention, a signal-bearing medium tangibly is provided embodying a program of machine-readable instruction executable by a digital processing apparatus to perform a process for defining transaction in an information technology offering that includes listing each transaction and each service that may be delivered over a computer network under the information technology offering, and partitioning the each transaction and the each service into at least one of a plurality of different classes.

In a further aspect of the present invention, a system for defining transactions in an information technology offering includes a transaction database comprising each transaction and each service that may be delivered over a computer network under the information technology offering, and a transaction classifier to partition the each transaction and the each service into at least one of a plurality of different classes.

In still a further aspect of the present invention, a service provider having a system for defining the value of services in an information technology offering, includes the service provider listing at least one transaction and service that may be delivered over a computer network to a customer under the information technology offering, partitioning the at least one transaction and service into at least one class, defining a usage rate of usage for the at least one class, defining at least one metric for measuring the rate of usage based upon the amount of customer service transactions within each of the at least one class, and translating the usage rate into a unit of service.

With the unique and unobvious aspects of the present invention, numerous advantages accrue. First, a single metric for received services and billing exists across varied IT services. The single metric is easily understood by end users (e.g. customers or consumers) since it reflects the customer's received services. Second, since the metric is independent of the infrastructure, a migration to a different infrastructure by the service provider is transparent to the customer or end user. Companies that use the sophistication of their IT infrastructures to distinguish themselves from their competitors can maintain access to different and powerful IT infrastructures without paying for initial capital investments in IT equipment and software. Thus, by paying for IT services based upon partitioning the transactions and services into different classes and using a standard metric for each class, customers can reduce their IT services costs.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 is a flow chart illustrating the steps of a process 100 of identifying suitable metrics for structuring an IT outsourcing contract;

FIG. 2 is a block diagram illustrating a possible implementation of a system 200 according to the present invention;

FIG. 3 is a block diagram illustrating modules of an exemplary implementation of a system 300 according to the present invention;

FIG. 4 illustrates an exemplary hardware/information handling system 400 for incorporating the present invention therein; and

FIG. 5 illustrates a signal bearing medium 500 (e.g. storage medium) for storing steps of a program of a method according to the present invention.

### DETAILED DESCRIPTION OF A PREFERRED EMBODIMENT OF THE INVENTION

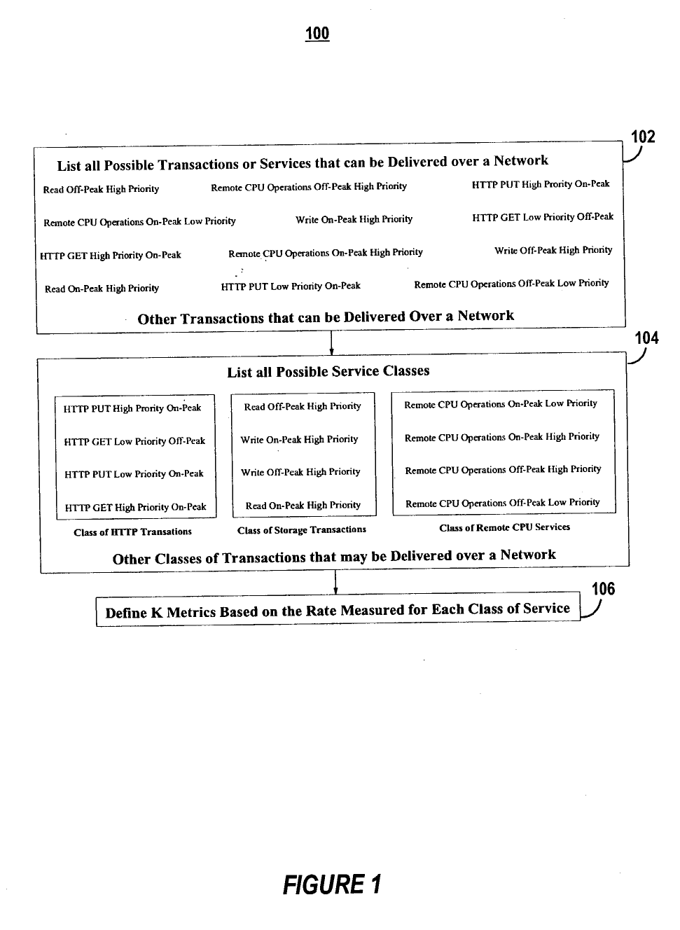

Referring now to the drawings, and more particularly to FIGS. 1-5, there are shown preferred embodiments of the method and structures according to the present invention.

Referring to FIG. 1, there is shown in the flow chart three steps of the preferred embodiment for identifying an appropriate set of metrics for measuring the information technology (IT) consumption of an organization.

The process 100 begins in function block 102, where all transactions and services that are of interest under an information technology offering or contract and that can be delivered over a network are gathered and listed. For example, possible transactions and services in such an offering include read and write off-peak and on-peak priorities, remote CPU operations, and HTTP GET and PUT operations. The gathering and listing can be performed by various methods including monitoring network transactions over a period of time, by consulting experts in the field, by interviewing the users served by the network, etc.

The process then moves to function block 104, where transactions and services are partitioned into classes. Classes can be defined by the user or customer or selected from standard lists of classes. The process of partitioning the transactions and services into classes can use different experts or methods as may be appropriate to conclude the process.

After the classes are defined, the process moves to function block 106, wherein metrics are defined based upon the rate of measurement for each class of service. For example, an expert may define K metrics having functions fₖ, k=1, . . . , K, that map the rates of the N classes into metrics that can be used to determine the overall rate of the IT operation.

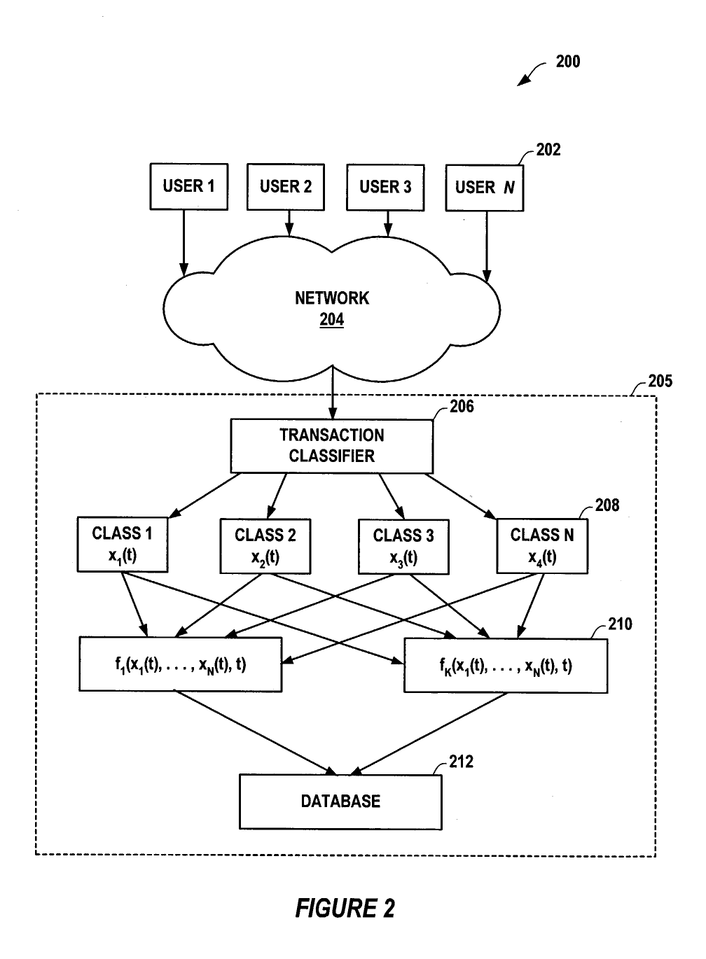

Turning to FIG. 2, it is shown that after the metrics are identified and determined, the process 200 captures the usage in terms of the metrics. Function blocks 202 represent the users of the services provided by the system. When a user 202 requests a service, the request is carried over the network 204 into the service provider 205. The provider's equipment may be located on-site or off-site. When a request arrives, a transaction classifier 206 determines the type of request at hand.

As each transaction belongs to a class of service, its rate of use is measured and associated with the appropriate class. This step is shown in function block series 208. Note that the rate, or resource consumption, is monitored over certain time intervals. The use over the time interval covering time t is the rate x(t). Since a user 202 might be using different services simultaneously, or since several users 202 may be using the system concurrently, each class has its own rate of use at time t, which is denoted by x₁(t), . . . , x_{N}(t). The rates of consumption are translated into units of service using the functions fₖ in function block series 210. The resulting rates are defined by yₖ(t); i.e., yₖ(t)=fₖ(x₁(t), . . . , x_{N}(t)), k=1, . . . , K, for all time periods t.

The resulting rates y₁(t), . . . , yₖ(t), are timestamped and stored in a database 212. The process is repeated at every time interval and the database 212 is updated accordingly by a new set of data representing the latest K rates. The measurements are assumed to be taken at specific points in time, which are defined by t, . . . , t_{T}.

In order to calculate the IT charges for a customer, it is assumed that the IT services contract specifies the method by which the rates x₁(t), . . . , x_{N}(t) over a certain time period are used to calculate the cost. The cost function is defined by g and the assumption is made that the cost function is known. Next, the IT charges are calculated as

g(y₁(t₁), . . . , y_{K}(t₁), y₁(t₂), . . . , y_{K}(t₂), . . . , y₁(t_{T}), . . . , y_{K}(t_{T})).

In an exemplary embodiment, the process of the present invention is used to define services for hosting an Internet Web site. Conventional Web hosting contracts use Megabits per second as the cost/billing base. However, such a billing method is a merely a measure of the required infrastructure and does not reflect the value of the service as perceived by the customer. The embodiment uses a high-level service metric which relates directly to the customer's value.

In Web hosting, the utility of a Web site is directly linked to the number of hits (e.g. the number of remote users logging onto the Web site). Therefore, customers prefer a measure that is based on the number of hypertext transfer protocol (HTTP) transactions. Two classes of HTTP traffic that can be distinguished are: the class of HTTP GET requests (e.g. the method by which a Web browser gets information from a server) and the class of HTTP secure sockets layer (SSL) (e.g. a transport level technology for authentication and data encryption between a Web server and a Web browser) requests. That is, the number of classes is N=2.

Depending on the IT contract, customers may prefer to have several metrics, i.e., K>1, for measuring the HTTP traffic. Using a large number of metrics increases specific ways by which consumption is measured. On the other hand, having a large number of metrics results in a large number of measurements which may complicate the process for an average user. In the exemplary embodiment for Web hosting, it is suggested to use one metric; i.e., K=1. A possible metric is one that calculates the average rate for the HTTP GET rates and HTTP SSL rates. Conventional HTTP transaction monitoring indicates that an HTTP SSL transaction is roughly equivalent to 10 HTTP GET requests. Therefore, the metric f₁(x₁(t), x₂(t))=x₁(t)+10x₂(t) is used where x₁(t), is the rate of the HTTP GET traffic and x₂(t) is the rate of HTTP SSL traffic at time t. The time over which the rates are calculated is a function of the Web site parameters. If hourly rates are used, then f₁, x₁, and x₂ are in units of transactions per hour. In this case t₁=t₂−t₁= . . . =t_{T}−t_{T-1}=1 hour. If the number of hits on the Web site is relatively large, then the hourly measurements may provide large numbers. To scale these values, the metric may be scaled. For example, f₁ is defined as scaled. For example, f₁ is defined as

$${f}_{1} ( {x}_{1} , {x}_{2} ) = \frac{{x}_{1} + 10 {x}_{2}}{60 , 000} \qquad ( 1 )$$

where 60,000 is a normalizing factor.

As K=1, the metric defined as (1) is referred to as a “Virtual Service Unit” (VSU). A VSU in the exemplary embodiment regarding Web hosting preferably represents the hosting capacity needed to serve a certain number of HTTP GET transactions and HTTP SSL transactions in one hour. Here, the VSU is the capacity needed to serve 60,000 HTTP GET transactions in an hour, serve 6,000 SSL transactions in an hour, or a linear interpolation between these two cases. That is, the number of VSU for a Web site can be calculated as follows:

$$\# VSU = \frac{\# HTTP GET / hour + 10 \times \# HTTP SSL / hour }{60 , 000} .$$

The VSU as defined in equation (1) is a measure of HTTP rate that can be used regardless of the intensity of the traffic. That is, the VSU measures the rate of regular traffic, bursty traffic, on-peak traffic, off-peak traffic, and so on. A customer can relate easily to the VSU as it reflects the number of hits on his/her Web site. More importantly, the platform that is serving the requests is transparent to the customer. In addition, since the metrics used in the preferred embodiment are not based on hardware infrastructure, the hardware or software used to host the Web site may be changed or upgraded without the need to alter the contract.

The above definition of a virtual server is relevant for the Web hosting business. As the units of service vary across businesses, an IT provider may opt to use several types of virtual service units. For example, one could define a VSU for CPU consumption and another for disk storage. In the case of storage capacity, a possible virtual service unit is the number of reads and writes to the storage device over a specific time period.

An additional exemplary embodiment preferably relates to data storage services. An increasing number of organizations have chosen to outsource their storage infrastructure. Some of the reasons are the explosive growth of data-intensive applications, the increased reliance on information as a competitive differentiator; storage management is labor intensive, and storage is often the largest component of a corporation's IT investment. Offering storage as a pay-as-you-go service has significant advantages, such as accommodating peak business workloads without a massive up-front investment, providing backup and restore capabilities locally and remotely to protect against data loss and damage, and offloading the high cost and risk of ownership associated with the storage infrastructure.

Conventional storage outsourcing practices charge customers based on the amount of data stored or, equivalently, charge the customers a lease fee for a dedicated storage device. However, in the exemplary embodiment metrics for measuring the value of the received data storage service are defined to include a measure of storage services in Megabytes-transferred per hour. The process for defining the metrics includes listing all storage services that may be delivered over the network such as network-attached storage, backup and restore, archiving, bare-metal restore, LAN-free backup and restore, and server-free backup and restore. The number of services in the example is N=6. All of these services fall under the umbrella of storage transactions.

Other units of measurement are possible depending on the characteristics of the stored data. For example, the rate can be calculated minute-by-minute or day-by-day. Also, in case of data files that have more or less the same size, the rate can be defined in terms of number of file-transfers per minute or hour. The rate for each class of service is denoted by x₁, . . . , x₆. Then, a possible metric for storage service is one that uses the same units as those used in measuring, xₙ, n=1, . . . , N. That is, K=1 and the function f₁(t) uses the same unit as that of xₙ.

However, different functions can be used at different time periods to measure the value of the service delivered, For example, there may be two functions: f₁(t₁) and f₂(1₂), where t₁ refers to the day period, while t₂ refers to the night period. By using two functions to measure the service, and by applying an appropriate billing function, customers are encouraged to exhibit certain behavior. In the example, assume that

$${f}_{1} ( x , {t}_{1} ) = {x}_{1 + α} {\sum }_{n = 2}^{N} {x}_{n}$$

where α is a large positive number.

Furthermore, assume that f₁(t₂) has the form:

$${f}_{1} ( x , {t}_{2} ) = {x}_{1 + α} {\sum }_{n = 2}^{N} {x}_{n}$$

Then, and assuming that charges are a function of f₁(t₁) and f₂(t₂), the customer is encouraged to back-up its storage over night since the rates x₂, . . . , x₆ measure the rates of backup services.

The number of services, hence the number of VSUs, is expected to grow as the IT marketplace evolves. A good approach is to keep the number of different offerings K to a minimum. Exemplary offerings for services include Web hosting, CPU capacity, and data storage. Each offering can be broken down into products. For example, for the Web-hosting offering could include an on-peak uninterruptible product, an off-peak uninterruptible product, and an on-peak interruptible product, and an off-peak interruptible product. The product type of virtual service unit is referred to as k by VSU-k, where k is an index that represents the nth product. It is assumed that there are K products; i.e., k=1, . . . , K. The following description is an exemplary embodiment of a process that can be used in billing based on the virtual service unit concept.

Input to the process of the preferred embodiment includes the price of a VSU for each of the K products. A product may be a well-defined and unique entity in a contract. That is, although two products may belong to the same offering, their prices may be different as they are differentiated in terms of their time horizon, time of use, quality of service, and delivery method, to name a few. The price for a virtual service unit of product k is defined as pₖ, k=1, . . . , K.

Regarding the contract structure, it is assumed that the system has a full description of the contract and its details. The contract could be as simple as having a fixed charge per VSU. In the preferred embodiment, the charges can be calculated by multiplying the number of VSUs of type k consumed during the billing period by pₙ and adding over all delivered products. That is, if the number of virtual service units of product k consumed during a billing cycle is xₖ, then the charges are Sₖ₌₁^{K}Pₖzₖ.

In general, IT contracts are rather complex and calculating the charges may involve complicated calculations. For example, a cell phone contract often provides the user with a certain number of minutes X for a fixed monthly charge of P. The user pays P as long as the total consumption x does not exceed X If x>X, then the user pays an additional amount of p per minute. That is, the total cost during a billing cycle is P+pₘₐₓ(x−X,0). In the preferred embodiment, a function ƒ and a computer implementation can calculate the total bill for a given set of contracted prices pₖ, k=1, . . . , K, and a corresponding consumption xₖ, k=1, . . . , K.

Regarding a billing cycle, some IT contracts charge monthly, while others charge quarterly. The frequency of billing is defined in the contract description. For example, a computerized system that triggers the billing calculations automatically at the appropriate time.

The process has access to the consumption data x₁, . . . , xₖ at each time interval; i.e., the number of virtual servers used of each product n. Consumption is measured periodically at time intervals that are suitable for the delivered service. This information can be stored in electronic form such as a database, and can be accessed upon demand.

When the calculations are triggered at the end of the cycle, the system retrieves the consumption data by issuing the appropriate queries and calculates the charges for that billing cycle. The calculations are performed through the function ƒ and the results (e.g. charges) are passed on to the billing system. As indicated before, ƒ is a function of pₖ, k=1, . . . , k, and xₖ, k=1, . . . , K. It is important to realize that f captures other information through the definition of xₖ, k=1, . . . , K. For example, if xₙ is defined as delivering service between 8:00 AM and 6:00 PM on a weekday, then xₖ=0 for periods between 6:00 PM and 8:00 AM.

The contract may also have thresholds and limits that further define the delivery service, such as data type or cost adjustments for consumed bandwidth.

The function f returns the total billing charges as system output. Other information may be reported as needed.

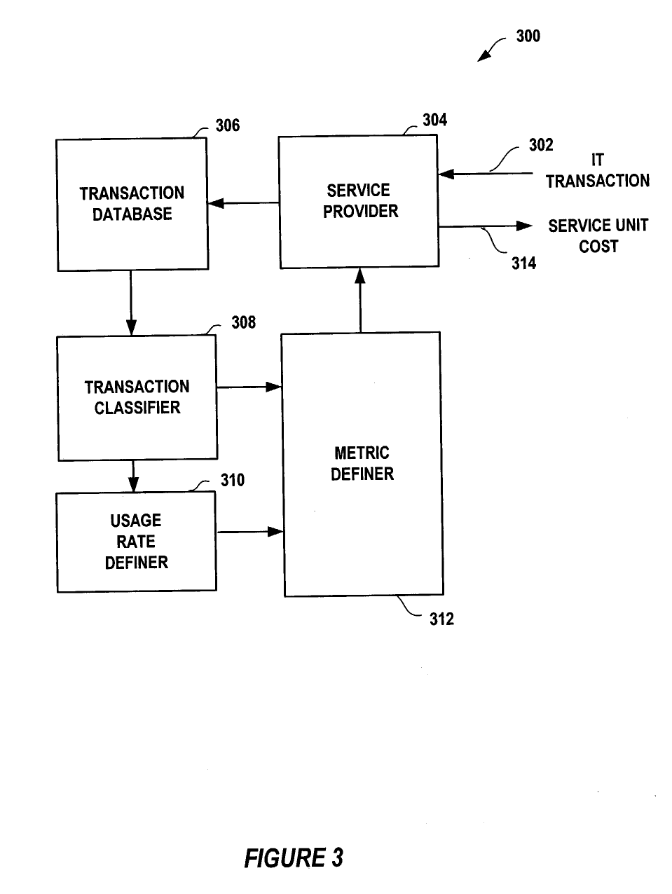

Turning to FIG. 3, there is shown in the block diagram an exemplary embodiment of a system 300 of the present invention. System 300 begins with an IT transaction 302 (e.g. a transaction or service) that is carried over a network and received into service provider 304. In Transaction Database 306, all transactions and services 302 that are of interest under an information technology offering or contract and that can be delivered over a network are gathered and listed. For example, possible transactions and services in such an offering include read and write off-peak and on-peak priorities, remote CPU operations, and HTTP GET and PUT operations. The gathering and listing into Transaction Database 306 can be performed by various methods including monitoring network transactions over a period of time, by consulting experts in the field, by interviewing the users served by the network, etc.

Transactions and services gathered in Transaction Database 306 are then partitioned into classes by transaction classifier 308. Classes can be defined by the user or customer or selected from standard lists of classes. The process of partitioning the transactions and services can use different experts or methods as may be appropriate and can be automated by Transaction Classifier 308 to provide greater efficiency;

After transactions are classified, the Defining Usage Rate module 310 defines the rate of use that is measured for each transaction and associated with each appropriate class. The Defining Usage Rate module 310 monitors usage rate over a time period for each transaction or service.

After the classes are defined in Transaction Classifier 308 and a usage rate is defined by Defining Usage Rate module 310, metrics are determined by the Defining Metric module 312 based upon the rate of measurement for each class of service, as defined above in the exemplary embodiment of a process of the present invention. Depending on the IT contract, customers may prefer to have several metrics for measuring an IT transaction or service. As stated above, an exemplary metric is the “virtual service unit” (VSU), which is a standard rate of measure of an IT transaction over a defined time period.

The Service Provider 304 then tracks the amount of network transactions or services sent to a customer and bills the costs 314 of the transactions according to the service unit rate using a billing module within the Service Provider 304.

Exemplary Hardware Implementation

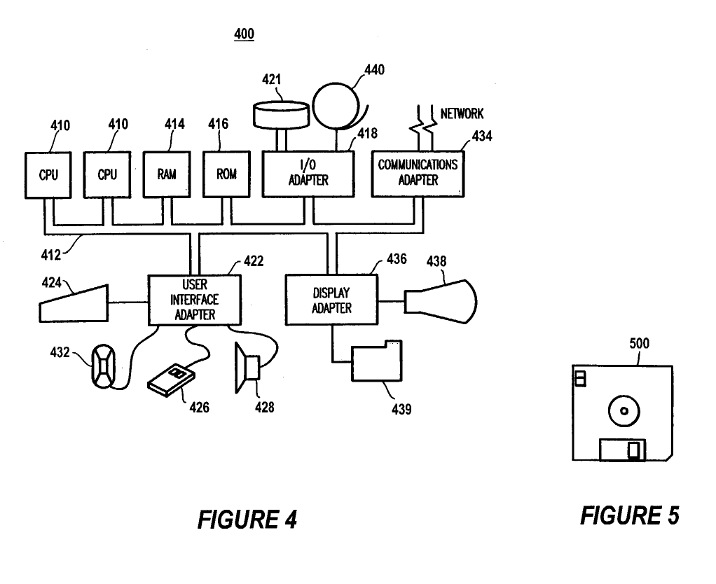

FIG. 4 illustrates a typical hardware configuration of an information handling/computer system for use with the invention and which preferably has at least one processor or central processing unit (CPU) 410.

The CPUs 410 are interconnected via a system bus 412 to a random access memory (RAM) 414, read-only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communication adapter 434 for connecting an information handling system to a data processing network, the Internet, an Intranet, a personal area network (PAN), etc., and a display adapter 436 for connecting the bus 412 to a display device 438 and/or printer 439 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 410 and hardware above, to perform the method of the invention. This signal-bearing media may include, for example, a RAM contained within the CPU 410, as represented by the fast-access storage for example. Alternatively, the instructions may be contained in another signal-bearing media, such as a magnetic data storage diskette 500 (FIG. 5), directly or indirectly accessible by the CPU 410.

Whether contained in the diskette 500, the computer/CPU 410, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

As described in the exemplary embodiment, the present invention provides a single metric for received services and billing for varied IT services. The single metric is easily understood by end users (e.g. customers or consumers) since it reflects the customer's received services. The metric is independent of the IT infrastructure, and therefore a migration to a different infrastructure by the service provider is transparent to the customer or end user. Offering services such as data storage or network applications (e.g. as an application service provider, or ASP) as a pay-as-you-go service has significant advantages, such as accommodating peak business workloads without a massive up-front investment, providing backup and restore capabilities locally and remotely to protect against data loss and damage, and offloading the high cost and risk of ownership associated with the storage infrastructure. Thus, companies can reduce their IT services costs and increase efficiencies by paying for IT services based upon a standard metric for each class of transaction.

While the invention has been described in terms of several preferred embodiments, those skilled in the art will recognize that the invention can be practiced with modification within the spirit and scope of the appended claims.

Further, it is noted that Applicants' intent is to encompass equivalents of all claim elements, even if amended later during prosecution.

Having thus described the invention, what is claimed as new and desired to be secured by Letters Patent is as follows:

1. A process for defining transactions in an information technology offering, comprising:
listing each transaction and each service that may be delivered over a computer network under the information technology offering; and
partitioning the each transaction and the each service into at least one of a plurality of different classes.

2. The process of claim 1, further comprising:
defining a usage rate of the classes; and
defining at least one metric for measuring the usage rate of each of the plurality of the classes that is independent of the information technology infrastructure.

3. The process of claim 2, further comprising:
translating the usage rate for the classes expressed in units of said metric into units of service.

4. The process of claim 3, wherein the units of service are based on a perceived value of the service by a customer.

5. The process of claim 3, further comprising:
billing a customer based upon a price per unit of service over a time interval.

6. The process of claim 5, further comprising:
repeating said process at a time interval; and
timestamping a measurement of the usage rate at the time interval for each said transaction and each said service from each of the classes.

7. The process of claim 2, wherein the defining at least one metric for measuring the usage rate comprises measuring hypertext transfer protocol (HTTP) traffic from a Web site with a virtual service unit,
wherein the virtual service unit comprises a service unit for hosting capacity to serve at least one HTTP transaction over a defined time interval.

8. The process of claim 5, wherein the billing a customer based upon a price per unit of service over a time interval comprises using a virtual service unit,
wherein the virtual service unit comprises a service unit for hosting capacity to serve at least one HTTP transaction over a defined time interval.

9. The process of claim 2, wherein the defining at least one metric for measuring the usage rate comprises measuring at least one data storage transaction over the network with a virtual service unit.

10. The process of claim 5, wherein the billing a customer based upon a price per unit of service over a time interval comprises measuring at least one data storage transaction over the network with a virtual service unit.

11. A process for defining a value of services in an information technology offering, comprising:
listing at least one transaction and service that may be delivered over a computer network to a customer under the information technology offering;
partitioning the at least one transaction and service into at least one class;
defining a rate of usage for the at least one class;
defining at least one metric for measuring the rate of usage based upon an amount of customer service transactions within each of the at least one class; and
translating the usage rate into a unit of service.

12. The process of claim 11, wherein the translating the usage rate comprises translating the usage rate into service units that are based on a perceived value of the service by the customer.

13. The process of claim 11, further comprising:
billing a customer based upon a price per a virtual unit of service over a time interval.

14. The process of claim 13, further comprising:
repeating said process at a time interval; and
timestamping the measurement of the usage rate at the time interval for the services used from each class.

15. The process of claim 11, wherein the defining at least one metric for measuring the usage rate comprises measuring hypertext transfer protocol (HTTP) traffic from a Web site with a virtual unit,
wherein the virtual unit comprises a service unit for hosting capacity to serve at least one HTTP transaction over a defined time period.

16. The process of claim 11, wherein the defining at least one metric for measuring the usage rate comprises measuring the amount of data storage transactions over the network with a unit of service.

17. The process according to claim 11, wherein the defining the at least one metric comprises defining a single metric across different services that is measured according to a time period, and wherein the single metric is independent of an infrastructure used in the services.

18. A method for calculating units of service associated with usage of information technology service, comprising:
listing each service that can be delivered over a computer network;
partitioning the each service into different classes;
defining at least one metric for measuring the rate of usage for each class;
measuring the usage of the service by a customer;
associating the measured service with the transaction rate for each class and determining a rate of usage for the each service; and
translating the rate of usage for the each service into a unit of service.

19. The method of claim 18, wherein the translating the rate of usage comprises translating the unit of service into a virtual unit that is based on the perceived value of the service by the customer.

20. The method of claim 19, further comprising:
billing a customer based upon a price per virtual unit of service over a time interval.

21. The method of claim 18, further comprising:
repeating said process at a time interval; and
timestamping the measurement of the usage rate at the time interval for the service used from each class.

22. The method of claim 18, wherein the defining at least one metric for measuring the usage rate measures hypertext transfer protocol (HTTP) traffic from a Web site with a virtual unit,
wherein the virtual unit comprises a service unit for hosting capacity to serve at least one HTTP transaction over a defined time period.

23. The method according to claim 18, wherein the defining at least one metric comprises defining a single metric across different services that is measured according to a time period, and
wherein the single metric is independent of the infrastructure used in each of the services.

24. A signal-bearing medium tangibly embodying a program of machine-readable instructions executable by a digital processing apparatus to perform a process for defining transactions in an information technology offering, said process comprising:
listing each transaction and each service that may be delivered over a computer network under the information technology offering; and
partitioning the each transaction and the each service into at least one of a plurality of different classes.

25. A system for defining transactions in an information technology offering, comprising:
a transaction database comprising each transaction and each service that may be delivered over a computer network under the information technology offering, and
a transaction classifier to partition the each transaction and the each service into at least one of a plurality of different classes.

26. The system of claim 25, further comprising:
a usage rate definer module for defining at least one usage rate for each of said classes.

27. The system of claim 25, further comprising:
a metric definer module for defining at least one metric for measuring the usage rate of each of said classes.

28. The system of claim 27, wherein the metric definer module for defining at least one metric for measuring the usage rate comprises a virtual service unit for measuring hypertext transfer protocol (HTTP) traffic from a Web site,
wherein the virtual service unit comprises a service unit for hosting capacity to serve at least one HTTP transaction over a defined time interval.

29. A service provider for defining the value of services in an information technology offering, comprising:
a transaction database comprising each transaction and each service that may be delivered over a computer network under the information technology offering, and
a transaction classifier to partition the each transaction and the each service into at least one of a plurality of different classes;
a usage rate definer module for defining at least one usage rate for each of said classes; and
a metric definer module for defining at least one metric for measuring the usage rate of each of said classes.

30. The service provider of claim 29, further comprising:
a billing module for billing costs of a virtual unit of service to the customer.
